(19) United States
(12) Patent Application Publication
(10) Pub. No.: US 2026/0131629 A1
(43) Pub. Date: May 14, 2026

(54) UNMANNED CARRIER ROBOT, MANAGEMENT DEVICE, AND MONITORING METHOD

(71) Applicant: MITSUBISHI ELECTRIC CORPORATION, Tokyo (JP)

(72) Inventors: Dongsuk PARK, Tokyo (JP); Miki ARAI, Tokyo (JP); Takayasu HASHIMOTO, Tokyo (JP); Yuri KUBOTA, Tokyo (JP); Misato WATANABE, Tokyo (JP)

(73) Assignee: MITSUBISHI ELECTRIC CORPORATION, Tokyo (JP)

(21) Appl. No.: 19/439,504

(22) Filed: Jan. 5, 2026

Related U.S. Application Data
(63) Continuation of application No. PCT/JP2023/029142, filed on Aug. 9, 2023.

(51) Int. Cl. B60H 1/00; B60H 3/02; B60P 7/08; B60R 25/01; B60R 25/102; B60R 25/30; B60R 25/34

(52) U.S. Cl. CPC B60H 1/00878; B60H 3/022; B60P 7/08; B60R 25/01; B60R 25/102; B60R 25/305; B60R 25/34

(57) ABSTRACT

An unmanned carrier robot according to the present disclosure is the unmanned carrier robot that carries a package to a user, and includes an anomaly determination unit that determines presence or absence of an anomaly in security related to the package on the basis of monitoring information indicating an occurrence state of an anomaly in security related to the package, and provides notification of occurrence of the anomaly in response to a determination of the anomaly.

### CROSS-REFERENCE TO RELATED APPLICATION

This application is a continuation application of International Application PCT/JP2023/029142, filed on Aug. 9, 2023, and designating the U.S., the entire contents of which are incorporated herein by reference.

### BACKGROUND OF THE INVENTION

### 1. Field of the Invention

The present disclosure relates to an unmanned carrier robot that carries a package, a management device, a carrier system, a monitoring method, and a storage medium.

### 2. Description of the Related Art

A service of carrying a package to a user using an unmanned carrier robot has attracted attention. Patent Literature 1 discloses an autonomous land vehicle that takes out a package transported by a truck and carries the taken-out package to a user. The autonomous land vehicle described in Japanese Patent No. 6773885 is an example of an unmanned carrier robot, and a lock mechanism is provided in a storage section for loading a package. The user inputs an access code using an input interface such as a keypad included in the autonomous land vehicle, so that the lock mechanism is unlocked and the package stored in the storage compartment can be taken out.

In the technique described in Japanese Patent No. 6773885, the storage section is locked so that any person other than the user cannot take out the package. However, locking alone may be insufficient as a security measure.

### SUMMARY OF THE INVENTION

In order to solve the above-described problems and achieve the object, an unmanned carrier robot according to the present disclosure is an unmanned carrier robot that carries a package to a user, the unmanned carrier robot comprising: an anomaly determination unit to determine presence or absence of an anomaly in security related to the package on the basis of monitoring information indicating an occurrence state of an anomaly in security related to the package, and provide notification of occurrence of the anomaly in response to a determination of the anomaly.

### BRIEF DESCRIPTION OF THE DRAWINGS

FIG. 1 is a diagram illustrating an exemplary configuration of a carrier system according to the first embodiment;

FIG. 2 is a diagram illustrating an example of a schematic external appearance of the unmanned carrier robot of the first embodiment;

FIG. 3 is a flowchart illustrating an example of the first anomaly determination process according to the first embodiment;

FIG. 4 is a flowchart illustrating an example of the second anomaly determination process according to the first embodiment;

FIG. 5 is a flowchart illustrating an example of the third anomaly determination process according to the first embodiment;

FIG. 6 is a flowchart illustrating an example of the fourth anomaly determination process according to the first embodiment;

FIG. 7 is a diagram illustrating an exemplary configuration of the carrier system of the first embodiment in a case where the anomaly determination unit is provided in the management device;

FIG. 8 is a diagram illustrating an exemplary configuration of processing circuitry that implements the control device of the first embodiment;

FIG. 9 is a diagram illustrating an exemplary configuration of a carrier system according to the second embodiment;

FIG. 10 is a sequence diagram illustrating an example of a process of providing sensor information according to the second embodiment;

FIG. 11 is a diagram illustrating an exemplary configuration of a carrier system according to the third embodiment;

FIG. 12 is a flowchart illustrating an example of the anomaly determination process according to the third embodiment;

FIG. 13 is a diagram illustrating an exemplary configuration of a carrier system according to the fourth embodiment;

FIG. 14 is a flowchart illustrating an example of the anomaly determination process according to the fourth embodiment; and

FIG. 15 is a diagram illustrating an example of the work mechanism of the fourth embodiment.

### DETAILED DESCRIPTION OF THE PREFERRED EMBODIMENTS

Hereinafter, an unmanned carrier robot, a management device, and a monitoring method according to embodiments will be described in detail with reference to the drawings.

### First Embodiment

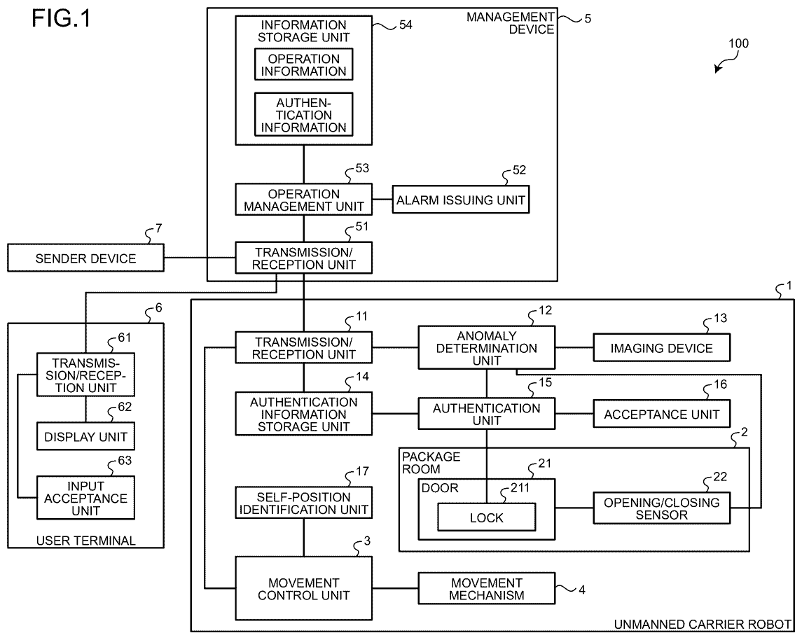

FIG. 1 is a diagram illustrating an exemplary configuration of a carrier system according to the first embodiment. The carrier system 100 of the present embodiment includes an unmanned carrier robot 1 and a management device 5 that manages the unmanned carrier robot 1. The unmanned carrier robot 1 can carry a package to a user. The unmanned carrier robot 1 may be a vehicle that travels on land, a drone (unmanned aerial vehicle), or the like. The unmanned carrier robot 1 is able to move in an unmanned manner, and may be a robot capable of autonomous traveling, or may be a robot capable of moving in an unmanned manner under the control of the management device 5 or another device (not illustrated). The carrier system 100 causes the unmanned carrier robot 1 to deliver a package to a user on the basis of a request from a sender who sends the package. The sender is a company or the like that arranges to send the package to the destination user in response to a request from the destination user of the package or a user other than the destination user. Although FIG. 1 illustrates one unmanned carrier robot 1, the number of unmanned carrier robots 1 is not limited to the example illustrated in FIG. 1, and only needs to be one or more.

A user terminal 6 is a terminal device that can be operated by the destination user of the package, and is, for example, a smartphone, a tablet, a smartwatch, a personal computer, or the like, but is not limited thereto. The user terminal 6 includes a transmission/reception unit 61 that communicates with other devices, a display unit 62 capable of displaying various types of information, images, and the like, and an input acceptance unit 63 that receives input from the user.

A sender device 7 is a device managed by the sender, and requests the carrier system 100 to carry the package to the destination user. For example, the sender device 7 transmits, to the management device 5, carry request information including the address of the destination user of the package, the place where the package is loaded, and information indicating the content of the package. For example, the sender device 7 performs processing of arranging to send the package to the destination user in response to a request from the destination user of the package or a user other than the destination user. This processing may be performed in any manner, and thus detailed description will be omitted. When the sender and the company managing the carrier system 100 are the same, the management device 5 may also have a function as the sender device 7.

In the present embodiment, the unmanned carrier robot 1 determines whether an anomaly in security has occurred, and when the anomaly in security has occurred, the unmanned carrier robot 1 notifies the management device 5 of the occurrence of the anomaly in security, and when the management device 5 is notified of the occurrence of the anomaly from the unmanned carrier robot 1, the management device 5 issues an alarm. As a result, the unmanned carrier robot 1 can enhance security. Details of the anomaly in security will be described later, but examples of the anomaly in security include unauthorized access to the unmanned carrier robot 1 and interception of the unmanned carrier robot 1. When being notified of the occurrence of the anomaly by the unmanned carrier robot 1, the management device 5 may notify the user terminal 6 and/or the sender device 7 of the anomaly. Alternatively, when an anomaly in security occurs, the unmanned carrier robot 1 may further notify the user terminal 6 and the sender device 7 of the anomaly.

As illustrated in FIG. 1, the management device 5 includes a transmission/reception unit 51, an alarm issuing unit 52, an operation management unit 53, and an information storage unit 54. The transmission/reception unit 51 communicates with other devices. For example, the transmission/reception unit 51 outputs the carry request information received from the sender device 7 to the operation management unit 53. When receiving information to be transmitted to the unmanned carrier robot 1 from the operation management unit 53, the transmission/reception unit 51 transmits the received information to the unmanned carrier robot 1. When receiving information from the unmanned carrier robot 1, the transmission/reception unit 51 outputs the received information to the operation management unit 53.

The operation management unit 53 manages the operation of the unmanned carrier robot 1. For example, when receiving the carry request information from the transmission/reception unit 51, the operation management unit 53 determines the unmanned carrier robot 1 for carrying the package corresponding to the carry request information on the basis of operation information indicating the operation plan for each unmanned carrier robot 1, that is, allocates the unmanned carrier robot 1 to the carry request corresponding to the carry request information, and updates the operation information on the determined unmanned carrier robot 1 on the basis of the carry request information. As will be described later, the operation information is stored in the information storage unit 54, and includes, for example, an operation schedule and a current position for each unmanned carrier robot 1. The operation schedule includes, for example, a scheduled carry start time, the loading place of a package, the carry destination of the package, and the content of the package. The operation schedule may include the content of the package to be carried. The operation schedule only needs to be information with which it is possible to grasp from where to where and when to carry, and specific items constituting the operation schedule are not limited to the above-described example.

Further, based on the operation information stored in the information storage unit 54, the operation management unit 53 generates control information for instructing the unmanned carrier robot 1 to move so that the unmanned carrier robot 1 can arrive at the loading place of the package at the carry start time of the unmanned carrier robot 1, and transmits the generated control information to the unmanned carrier robot 1 via the transmission/reception unit 51. Alternatively, operation information corresponding to the unmanned carrier robot 1 may be transmitted to the unmanned carrier robot 1, and the unmanned carrier robot 1 may move on the basis of the operation information. The method for managing the operation of the unmanned carrier robot 1 by the management device 5 and the method for controlling the movement of the unmanned carrier robot 1 are not limited to the above-described examples.

In addition, the operation management unit 53 generates, on the basis of the carry request information, authentication information to be used when the destination user of the package corresponding to the carry request information takes out the package carried by the unmanned carrier robot 1 from the unmanned carrier robot 1, stores the generated authentication information in the information storage unit 54, and transmits the generated authentication information to the unmanned carrier robot 1 via the transmission/reception unit 51. The authentication information may be a combination of numbers, a combination of characters, a combination of numbers and characters, a combination of numbers, characters, and symbols, or other information.

In addition, the operation management unit 53 notifies the destination user of the package of the generated authentication information. For example, in a case where the carry request information includes user information which is information to be transmitted to the user terminal 6 corresponding to the destination user of the package, the operation management unit 53 transmits the generated authentication information to the user terminal 6. Note that the operation management unit 53 may transmit the generated authentication information to the sender device 7, and the sender device 7 may transmit the authentication information to the user terminal 6. The user information may be the phone number of a mobile phone, an email address, a user identifier (ID) determined at the time of registration for the user to receive a package carry service, or other information. In a case where the user information is the phone number of a mobile phone, the authentication information is transmitted as a short message service (SMS) to the user terminal 6 having a function as a mobile phone such as a smartphone. In a case where the user information is an email address, the authentication information is transmitted to the user terminal 6 as, for example, an email. In a case where the user information is a user ID determined at the time of registration, the authentication information may be transmitted to the user terminal 6 by logging in to a website or application software (hereinafter abbreviated as an app) for receiving a service.

In addition, when receiving anomaly information indicating occurrence of anomaly from the unmanned carrier robot 1 via the transmission/reception unit 51, the operation management unit 53 instructs the alarm issuing unit 52 to issue an alarm. The anomaly information may include details of the generated anomaly, that is, information indicating what kind of anomaly has occurred. In the present embodiment, as will be described later, an anomaly determination unit 12 may perform a plurality of anomaly determination processes, and in a case where the anomaly determination unit 12 performs a plurality of anomaly determination processes, the content of the anomaly may include, for example, information indicating which anomaly determination process has determined the anomaly. In this case, when instructing the alarm issuing unit 52 to issue an alarm, the operation management unit 53 notifies the alarm issuing unit 52 of the content of the anomaly.

The information storage unit 54 stores operation information and authentication information. The alarm issuing unit 52 issues an alarm when the transmission/reception unit 11 receives anomaly information, that is, receives an instruction to issue an alarm from the operation management unit 53. The alarm is issued by, for example, one or more of display, sound, alarm sound, light emission such as a lamp, and notification of occurrence of anomaly to another device such as a mobile terminal carried by an administrator who manages the carrier system 100, but may be issued using other methods. When being notified of the content of the anomaly by the operation management unit 53, the alarm issuing unit 52 also includes the content of the anomaly in the alarm. For example, in a case where the alarm is issued by display, the content of the anomaly is displayed, in a case where the alarm is issued by voice, the content of the anomaly is issued by voice, and in a case where the alarm is issued by notification of occurrence of the anomaly to another device, the content of the anomaly is included in the notification. In a case where the alarm is issued by light emission of a lamp or the like, the color of light emission may be changed or the blinking pattern may be changed according to the content of the anomaly. In a case where the alarm sound is used for the alarm, the alarm sound may differ according to the content of the anomaly.

In addition, in a case where position information indicating the position of the unmanned carrier robot 1 is received from the unmanned carrier robot 1 via the transmission/reception unit 51, the operation management unit 53 may also notify the alarm issuing unit 52 of the position information when instructing the alarm issuing unit 52 to issue an alarm. As a result, for example, the alarm issuing unit 52 may display the position of the unmanned carrier robot 1 on a map when displaying an alarm. The alarm issuing unit 52 may also transmit information indicating the position of the unmanned carrier robot 1 when notifying another device of the occurrence of the anomaly.

As illustrated in FIG. 1, the unmanned carrier robot 1 includes a package room 2, a movement control unit 3, a movement mechanism 4, a transmission/reception unit 11, an anomaly determination unit 12, an imaging device 13, an authentication information storage unit 14, an authentication unit 15, an acceptance unit 16, and a self-position identification unit 17.

The package room 2 includes a door 21 and an opening/closing sensor 22 that detects opening/closing of the door 21. The door 21 has a lock 221. The lock 211 can be electronically locked and unlocked, and is locked when a package is loaded into the package room 2, and is unlocked by an unlocking instruction from the authentication unit 15. The authentication unit 15 may unlock the lock 211, or an unlocking unit (not illustrated) may unlock the lock based on an authentication result from the authentication unit 15. Note that, although an example in which the package room 2 is provided is described here, the package room 2 is an example of a holding unit that holds a package, and the holding unit is not limited to the package room 2. The holding unit only needs to be capable of loading or holding a package, and may be, for example, a table on which a package is loaded or not enclosed, a robot arm in a case where the unmanned carrier robot 1 carries a package with a robot arm, a portion corresponding to a hand in a case where the unmanned carrier robot 1 is a humanoid robot, or the like, or may be other than these.

The opening/closing sensor 22 is a sensor that detects opening/closing of the door 21, and when detecting that the door 21 has been opened, notifies the anomaly determination unit 12 that the door 21 has been opened as a detection result. Alternatively, the opening/closing sensor 22 may notify the anomaly determination unit 12 of information indicating whether the door 21 is opened at a constant cycle as a detection result. The detection result by the opening/closing sensor 22 is open/close information indicating the open/close state of the door 21. The opening/closing sensor 22 is provided, for example, on the door 21, but is not limited thereto, and may be a sensor that is installed inside the package room 2 and detects opening of the door 21 by detecting a certain amount or more of light.

The transmission/reception unit 11 communicates with other devices. For example, when receiving the authentication information from the management device 5, the transmission/reception unit 11 stores the received authentication information in the authentication information storage unit 14. The authentication information is used for authentication for unlocking the lock 211 of the door 21 of the package room 2. When receiving the control information from the management device 5, the transmission/reception unit 11 outputs the received control information to the movement control unit 3. When receiving anomaly information indicating that an anomaly has occurred from the anomaly determination unit 12, the transmission/reception unit 11 transmits the anomaly information to the management device 5.

The self-position identification unit 17 identifies the position of the unmanned carrier robot 1, and outputs position information indicating the identified position to the movement control unit 3. The self-position identification unit 17 may identify the position by performing positioning using a satellite positioning system such as a global positioning system (GPS) or a global navigation satellite system (GNSS), may acquire imaging data obtained by imaging the surroundings as information indicating position information, or may identify the position with a method other than these. That is, the position information may be a positioning result using a satellite positioning system, may be imaging data indicating a captured image, or may be other information. The movement control unit 3 controls the movement mechanism 4 on the basis of the position information received from the self-position identification unit 17, the control information received from the transmission/reception unit 11, and information received from a sensor for controlling movement (not illustrated). Examples of the sensor for controlling movement include, but are not limited to, a light detection and ranging (LiDAR) sensor, a millimeter wave sensor, and the like. The movement mechanism 4 is a mechanism for moving the unmanned carrier robot 1, and may be a movement mechanism including wheels or a crawler type movement mechanism. When the unmanned carrier robot 1 is an aircraft, the movement mechanism 4 may be a movement mechanism using a propeller. The movement control unit 3 may transmit the position information received from the self-position identification unit 17 to the management device 5 via the transmission/reception unit 11. Alternatively, the self-position identification unit 17 may output the position information to the transmission/reception unit 11, and the transmission/reception unit 11 may transmit the position information to the management device 5.

The authentication information storage unit 14 stores authentication information. The acceptance unit 16 accepts the input of the authentication information and outputs the accepted authentication information to the authentication unit 15. The authentication unit 15 performs authentication on the basis of the authentication information accepted by the acceptance unit 16, that is, the authentication information received from the acceptance unit 16, and outputs an authentication result. Specifically, the authentication unit 15 performs authentication using the authentication information stored in the authentication information storage unit 14 and the authentication information received from the acceptance unit 16, and unlocks the lock 211 when determining the authentication success. The authentication unit 15 notifies the anomaly determination unit 12 of an authentication result, that is, information indicating whether the authentication has succeeded or failed. Note that examples of the authentication method in the authentication unit 15 include, but are not limited to, a method of determining whether the authentication information stored in the authentication information storage unit 14 and the authentication information received from the acceptance unit 16 have a predetermined relationship, a method of determining whether the authentication information stored in the authentication information storage unit 14 matches the authentication information received from the acceptance unit 16, and the like. The authentication method in the authentication unit 15 may be, for example, a method of determining whether a value obtained by adding a numerical value defined to the numerical value indicated by the authentication information accepted by the acceptance unit 16 matches the numerical value indicated by the authentication information stored in the authentication information storage unit 14. In addition, the authentication in the authentication unit 15 may be biometric authentication such as face authentication, fingerprint authentication, or iris authentication.

The imaging device 13 images the surroundings of the unmanned carrier robot 1, and outputs imaging data obtained by imaging to the anomaly determination unit 12. The imaging device 13 is, for example, a camera, and may be a camera used for movement control in the movement control unit 3, or may be provided separately from the camera used for movement control. Furthermore, a plurality of imaging devices 13 may be provided, and some of the plurality of imaging devices 13 may be cameras used for movement control.

The anomaly determination unit 12 determines the presence or absence of an anomaly in security related to a package on the basis of monitoring information that is information indicating the occurrence state of the anomaly in security related to the package, and provides notification of the occurrence of the anomaly in response to a determination of the anomaly. For example, the anomaly determination unit 12 generates anomaly information indicating that an anomaly has occurred, and outputs the generated anomaly information to the transmission/reception unit 11 to provide notification of the occurrence of the anomaly. The transmission/reception unit 11 transmits the anomaly information to, for example, the management device 5. The monitoring information includes, for example, at least one of an authentication result by the authentication unit 15 (notification from the authentication unit 15), a detection result by the opening/closing sensor 22 (open/close information indicating the open/close state of the door 21), and imaging data received from the imaging device 13, but may include other information.

For example, the anomaly determination unit 12 may determine the presence or absence of an anomaly by using the number of authentication failures by the authentication unit 15, may determine the presence or absence of an anomaly by a combination of an authentication result by the authentication unit 15 and a detection result by the opening/closing sensor 22, or may determine the presence or absence of an anomaly by using a result obtained by analyzing the imaging data. Details of the anomaly determination in the anomaly determination unit 12 will be described later.

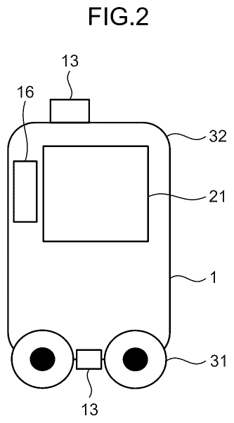

FIG. 2 is a diagram illustrating an example of a schematic external appearance of the unmanned carrier robot 1 of the present embodiment. In the example illustrated in FIG. 2, the unmanned carrier robot 1 includes wheels 31 which are a part of the movement mechanism 4. In the example illustrated in FIG. 2, the unmanned carrier robot 1 includes a housing 32, a control device not illustrated in FIG. 2 is provided in the housing 32, and the control device includes the anomaly determination unit 12, the authentication information storage unit 14, the authentication unit 15, and the movement control unit 3 illustrated in FIG. 1. Note that the control device including the movement control unit 3 and the control device including the anomaly determination unit 12, the authentication information storage unit 14, and the authentication unit 15 may be provided separately. At least a part of the control device may be provided outside the housing 32. Although the transmission/reception unit 11 and the self-position identification unit 17 are also provided in the housing 32, some or all of these devices may be provided outside the housing 32. At least a part of the transmission/reception unit 11 and the self-position identification unit 17 may be provided in the control device described above.

In the example illustrated in FIG. 2, the acceptance unit 16 is provided beside the door 21. The acceptance unit 16 may be, for example, an input device that accepts input of numbers, such as a numeric keypad, or an input device such as a keyboard, a touch panel, or a button, and may be any input device that can accept input of authentication information. A space for placing a package in the package room 2 exists behind the door 21. When the package is loaded, the door 21 is opened, the package is placed in the package room 2, and the lock 211 (not illustrated in FIG. 2) is locked. When receiving the package, the user operates the acceptance unit 16 to input the authentication information, and when the authentication is successful, the lock 211 (not illustrated in FIG. 2) of the door 21 is unlocked, and the package can be received.

In addition, in the example illustrated in FIG. 2, the imaging devices 13 are provided at two positions: the upper portion of the housing 32 and the bottom surface of the housing 32. The number and arrangement positions of the imaging devices 13 are not limited to the example illustrated in FIG. 2. FIG. 2 is an example, and the shape of the unmanned carrier robot 1, the method of the movement mechanism 4, the position, size, and shape of the door 21, and the position, size, and shape of the acceptance unit 16 are not limited to the example illustrated in FIG. 2.

Next, a specific example of the monitoring method of the present embodiment, that is, the anomaly determination method will be described. There is a possibility that a security problem occurs during a period from when a package is loaded on the unmanned carrier robot 1 until the user receives the package. In the present embodiment, when there is a possibility that a security problem has occurred, the anomaly determination unit 12 determines that an anomaly has occurred and notifies the management device 5 of the occurrence of the anomaly via the transmission/reception unit 11.

Examples of the anomaly in security include an example in which a third person who is neither the destination user of the package nor the administrator who manages the package opens the door 21 to take the package, an example in which a third person takes away the unmanned carrier robot 1 itself, and an example in which a third person destroys the unmanned carrier robot 1.

As an anomaly determination process of determining that there is a possibility that such a problem has occurred as anomaly, the unmanned carrier robot 1 of the present embodiment can perform an anomaly determination process using the number of authentication failures. Hereinafter, the anomaly determination process using the number of authentication failures is also referred to as a first anomaly determination process. Since the third person does not know the correct authentication information, there is a possibility that the third person operates the acceptance unit 16, inputs codes repeatedly, and tries to open the door 21. Therefore, the anomaly determination unit 12 of the unmanned carrier robot 1 can determine that the anomaly has occurred when the number of authentication failures becomes equal to or larger than a threshold.

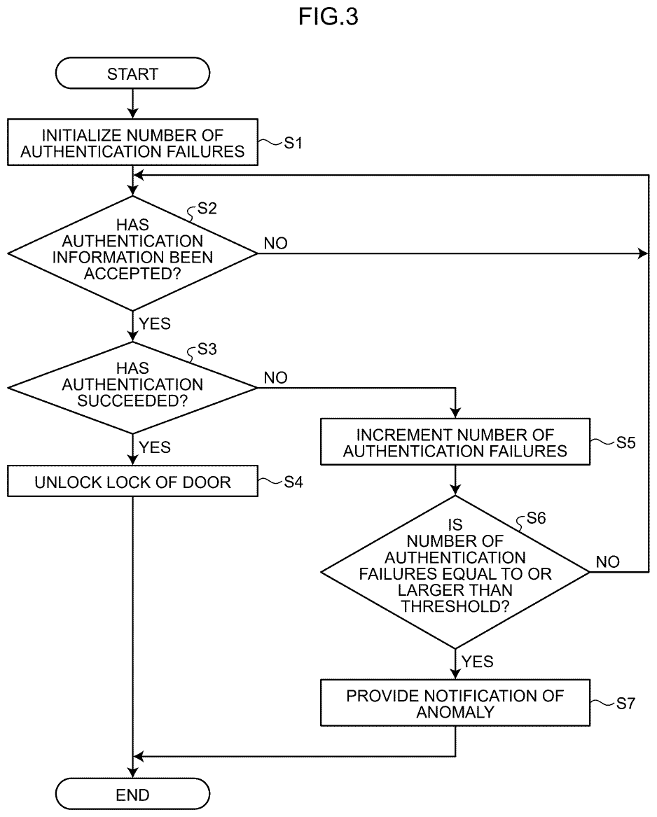

FIG. 3 is a flowchart illustrating an example of the first anomaly determination process according to the present embodiment. The process illustrated in FIG. 3 is started, for example, during a period from when a package is loaded on the unmanned carrier robot 1 and the door is locked to when the unmanned carrier robot 1 departs to the destination of the package, but the timing at which the process illustrated in FIG. 3 is started is not limited thereto.

As illustrated in FIG. 3, the unmanned carrier robot 1 initializes the number of authentication failures which is the number of authentication failures (step S1). Specifically, the anomaly determination unit 12 sets the number of authentication failures to zero which is an initial value.

The unmanned carrier robot 1 determines whether the authentication information has been accepted (step S2). Specifically, the authentication unit 15 determines whether the authentication information has been received from the acceptance unit 16. When the authentication information has not been accepted (No in step S2), step S2 is repeated. When the authentication information has been accepted (Yes in step S2), the unmanned carrier robot 1 determines whether the authentication has succeeded (step S3). Specifically, the authentication unit 15 performs authentication using the authentication information received from the acceptance unit 16 and the authentication information stored in the authentication information storage unit 14, and notifies the anomaly determination unit 12 of the authentication result.

When the authentication success is determined (Yes in step S3), the unmanned carrier robot 1 unlocks the lock 211 of the door 21 (step S4), and ends the process. In step S4, specifically, the authentication unit 15 outputs an unlocking instruction to the lock 211, whereby the lock 211 is unlocked.

When the authentication failure is determined (No in step S3), the unmanned carrier robot 1 increments the number of authentication failures (step S5). In step S5, specifically, the authentication unit 15 notifies the anomaly determination unit 12 of the authentication failure as the authentication result, and the anomaly determination unit 12 increments the number of authentication failures by adding one to the number of authentication failures.

Next, the unmanned carrier robot 1 determines whether the number of authentication failures is equal to or larger than the threshold (step S6). Specifically, the anomaly determination unit 12 determines whether the number of authentication failures is equal to or larger than the threshold. The threshold may be an integer of one or more, and is set in advance by, for example, an administrator or the like, but may be changed after being set.

When the number of authentication failures is less than the threshold (No in step S6), the unmanned carrier robot 1 repeats the process from step S2. When the number of authentication failures is equal to or larger than the threshold (Yes in step S6), the unmanned carrier robot 1 provides notification of anomaly (step S7), and ends the process. In step S7, specifically, the anomaly determination unit 12 determines that there is an anomaly when the number of authentication failures is equal to or larger than the threshold, generates anomaly information indicating that the anomaly has occurred, and transmits the generated anomaly information to the management device 5 via the transmission/reception unit 11. That is, the transmission/reception unit 11 has a function as a transmission unit that transmits anomaly information to the management device 5. As described above, the anomaly information may also be transmitted to the user terminal 6 and/or the sender device 7. In the management device 5, the transmission/reception unit 51 having a function as a reception unit that receives the anomaly information receives the anomaly information. When the transmission/reception unit 51 receives the anomaly information, the alarm issuing unit 52 issues an alarm according to an instruction of the operation management unit 53. The administrator who has recognized issuing of the alarm implements a countermeasure. For example, a worker may be arranged to confirm the state of the unmanned carrier robot 1, or the user of the destination of the package may be contacted to confirm whether the authentication information has been erroneously input, or other countermeasures may be taken.

As described above, in the first anomaly determination process, the monitoring information includes the authentication result by the authentication unit 15, and the anomaly determination unit 12 determines the presence or absence of an anomaly on the basis of the authentication result by the authentication unit 15. For example, the anomaly determination unit 12 determines an anomaly when the number of times of determination of the authentication failure by the authentication unit 15 is equal to or larger than the threshold.

In addition, instead of transmitting the anomaly information to the management device 5, or while transmitting the anomaly information to the management device 5, an alarm device (not illustrated) included in the unmanned carrier robot 1 may be activated. When activated, the alarm device provides notification of the surroundings of the anomaly by issuing a warning sound or the like, for example.

Next, a second anomaly determination process will be described. In a case where the door 21 is forcibly opened, for example, the door 21 is opened in a state where the authentication is not successful. For this reason, the anomaly determination unit 12 of the unmanned carrier robot 1 may determine the unauthorized opening of the door as the anomaly. For example, the anomaly determination unit 12 can determine whether an anomaly has occurred based on the authentication result and the detection result by the opening/closing sensor 22.

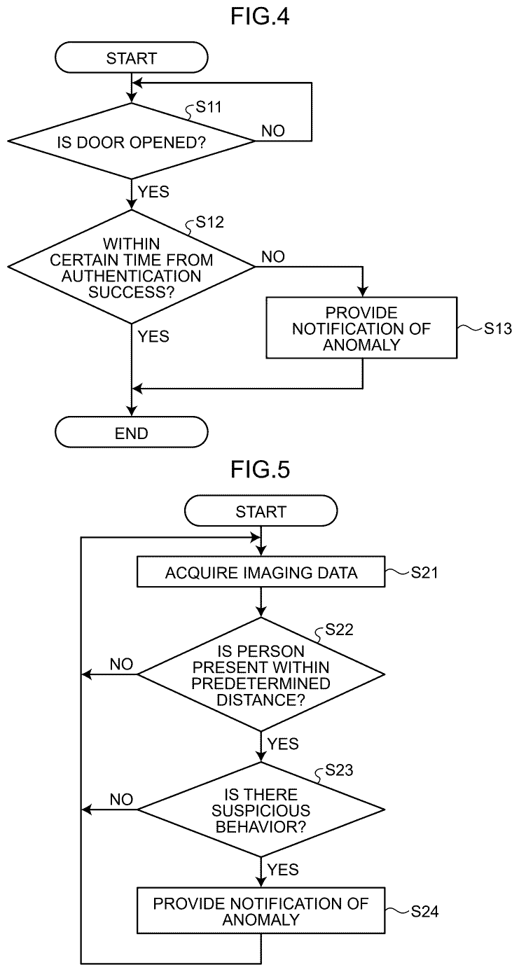

FIG. 4 is a flowchart illustrating an example of the second anomaly determination process according to the present embodiment. The process illustrated in FIG. 4 is started, for example, during a period from when a package is loaded on the unmanned carrier robot 1 and the door is locked to when the unmanned carrier robot 1 departs to the destination of the package, but the timing at which the process illustrated in FIG. 4 is started is not limited thereto.

As illustrated in FIG. 4, the unmanned carrier robot 1 determines whether the door 21 is opened (step S11). Specifically, the anomaly determination unit 12 determines whether the door 21 is opened based on the detection result received from the opening/closing sensor 22.

When it is determined that the door 21 is not opened (No in step S11), the unmanned carrier robot 1 repeats the process in step S11. When it is determined that the door 21 is opened (Yes in step S11), the unmanned carrier robot 1 determines whether it is within a certain time from the authentication success (step S12). Specifically, the anomaly determination unit 12 determines whether the elapsed time from the time point at which the notification of the authentication success is given is within the certain time on the basis of the authentication result provided from the authentication unit 15.

When it is within the certain time from the authentication success (Yes in step S12), the unmanned carrier robot 1 ends the process. When it is not within the certain time from the authentication success (No in step S12), that is, for example, when the elapsed time from the determination of the authentication success exceeds the certain time, or when the authentication has never been performed, the unmanned carrier robot 1 provides notification of the anomaly (step S13). For example, even in a case where the door 21 is illegally opened before the authentication is performed after the sender has loaded and locked the package room of the unmanned carrier robot 1 and has performed the process of starting shipment, the unmanned carrier robot 1 determines that there is an anomaly and provides notification of the anomaly. The anomaly notification method is similar to that in step S7.

As described above, in the second anomaly determination process, the monitoring information includes the authentication result by the authentication unit 15 and the open/close information indicating the open/close state of the door 21, and it is sufficient to determine an anomaly when the door 21 is opened at a time other than a predetermined time (the certain time) after the determination of the authentication success, and the process in the anomaly determination unit 12 is not limited to the above-described example.

Next, a third anomaly determination process will be described. In a case where the unmanned carrier robot 1 undergoes an action that affects the package such as destroying the unmanned carrier robot 1 to take the package, taking the unmanned carrier robot 1 itself, or damaging the unmanned carrier robot 1, a person who approaches the unmanned carrier robot 1 may show suspicious behavior different from usual. For this reason, the anomaly determination unit 12 of the unmanned carrier robot 1 can determine whether an anomaly has occurred by determining whether there is a person who performs suspicious behavior based on the imaging data, for example.

FIG. 5 is a flowchart illustrating an example of the third anomaly determination process according to the present embodiment. The process illustrated in FIG. 5 is started, for example, during a period from when a package is loaded on the unmanned carrier robot 1 and the door is locked to when the unmanned carrier robot 1 departs to the destination of the package, but the timing at which the process illustrated in FIG. 5 is started is not limited thereto.

As illustrated in FIG. 5, the unmanned carrier robot 1 acquires imaging data (step S21). Specifically, the imaging device 13 acquires imaging data (first imaging data) by imaging the surroundings of the unmanned carrier robot 1, and outputs the acquired imaging data to the anomaly determination unit 12. The number of imaging devices 13 may be one or more. In order to detect a person approaching the unmanned carrier robot 1 from various directions, the imaging devices 13 may be configured to image all directions around the unmanned carrier robot 1, or some directions that a person is likely to approach may be determined in advance, and the imaging devices 13 may be arranged to image only the determined directions. In the case of imaging all directions around the unmanned carrier robot 1, an omnidirectional camera may be used as the imaging device 13, or a plurality of imaging devices 13 having different imaging directions may be used.

The unmanned carrier robot 1 determines whether a person is present within a predetermined distance (step S22). Specifically, the anomaly determination unit 12 detects a person from the video indicated by the imaging data received from the imaging device 13 using image recognition technology, and estimates the distance between the unmanned carrier robot 1 and the person based on the size of the region corresponding to the detected person, the position of the region in the video, and the angle of view of the imaging device 13. Then, the anomaly determination unit 12 determines whether a person is present in a range where the distance from the unmanned carrier robot 1 is within a predetermined distance. As a method of detecting a person from the video, any method may be used, and for example, a method using image recognition technology by machine learning may be used, or other methods may be used. For example, skeleton detection for detecting a skeleton of a person by machine learning may be used.

When there is no person within the predetermined distance (No in step S22), the process from step S21 is repeated. When a person is within the predetermined distance (Yes in step S22), the unmanned carrier robot 1 determines whether there is suspicious behavior (step S23). Specifically, in step S22, the behavior of the person determined to be within the range of the predetermined distance from the unmanned carrier robot 1 is analyzed, and whether the analyzed behavior is a predetermined suspicious behavior is determined. For example, by using a detection result of skeleton detection by machine learning, it is determined whether the behavior of the person corresponds to a predefined suspicious behavior. Examples of the predefined suspicious behavior may include, but are not limited to, a behavior of forcibly opening the door 21 of the package room 2 of the unmanned carrier robot 1 (a behavior of opening the door 21 for a long time), a behavior of hitting the unmanned carrier robot 1 with an object, a behavior of approaching the unmanned carrier robot 1 with a bar or the like having a certain size or more in hand, a behavior of raising the unmanned carrier robot 1, a behavior of holding the unmanned carrier robot 1 with feet, a behavior of throwing an object at the unmanned carrier robot 1, and the like.

When there is no suspicious behavior (No in step S23), the process from step S21 is repeated. When there is a suspicious behavior (Yes in step S23), the unmanned carrier robot 1 provides notification of anomaly (step S24), and the process from step S21 is repeated. The anomaly notification method in step S24 is similar to that in step S7.

As described above, in the third anomaly determination process, the monitoring information includes the first imaging data obtained by imaging the surroundings of the unmanned carrier robot 1, and the anomaly determination unit 12 determines whether there is a person who performs a predetermined suspicious behavior within a range in which the distance from the unmanned carrier robot 1 is within a predetermined distance using the first imaging data, and determines an anomaly in response to determining that there is a person who performs a suspicious behavior within the range.

Next, a fourth anomaly determination process will be described. When the unmanned carrier robot 1 is taken away, the state of the unmanned carrier robot 1 is different from the normal state. For example, when the unmanned carrier robot 1 moves on the land, the wheels 31 of the unmanned carrier robot 1 are on the ground in the exemplary configuration of FIG. 2. Because the wheels 31 are separated from the ground as the unmanned carrier robot 1 is lifted up, the anomaly determination unit 12 of the unmanned carrier robot 1 can determine whether the anomaly has occurred by monitoring the distance between the wheels 31 and the ground based on the imaging data, for example. Note that, here, as illustrated in FIG. 2, the imaging device 13 is provided on the bottom surface of the housing 32 so that the distance between the wheels 31 and the ground can be detected, but a sensor that detects the distance between the bottom surface and the ground may be used instead of the imaging device 13. In addition, in a case where the unmanned carrier robot 1 is a drone or the like, after landing, the anomaly determination unit 12 detects the distance between the lowest portion of the unmanned carrier robot 1, which is normally in contact with the ground, and the ground, so that it is possible to similarly determine the occurrence of anomaly.

When the unmanned carrier robot 1 moves in a building, the unmanned carrier robot 1 may move on the floor surface. In such a case, for example, the anomaly determination unit 12 can determine the occurrence of anomaly by monitoring the distance between the wheels 31 and the floor surface. That is, the anomaly determination unit 12 only needs to monitor the distance between a reference surface and the lowermost portion of the unmanned carrier robot 1, and the reference surface is a surface orthogonal to the vertical direction, and may be a ground surface, a floor surface, or other surfaces, and may be a surface with which the lowermost portion of the unmanned carrier robot 1 is in contact in a normal state.

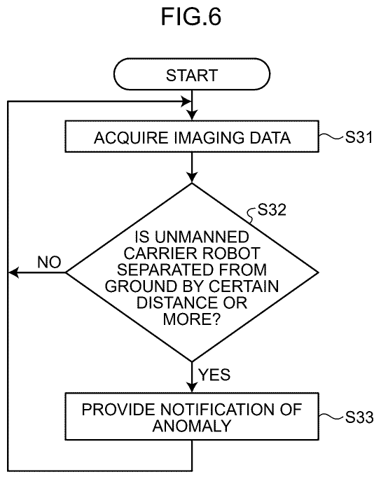

FIG. 6 is a flowchart illustrating an example of the fourth anomaly determination process according to the present embodiment. The process illustrated in FIG. 6 is started, for example, during a period from when a package is loaded on the unmanned carrier robot 1 and the door is locked to when the unmanned carrier robot 1 departs to the destination of the package, but the timing at which the process illustrated in FIG. 6 is started is not limited thereto. In a case where the unmanned carrier robot 1 is a drone or the like as described above, the process illustrated in FIG. 6 may start after landing.

As illustrated in FIG. 6, the unmanned carrier robot 1 acquires imaging data (step S31). Specifically, the imaging device 13 acquires imaging data (second imaging data) by imaging an area below the unmanned carrier robot 1. For example, the imaging device 13 installed so as to be able to detect the distance between the portion where the unmanned carrier robot 1 is in contact with the ground and the ground or the distance between the bottom surface of the unmanned carrier robot 1 and the ground acquires imaging data (second imaging data) by imaging a region including the ground, and outputs the acquired imaging data to the anomaly determination unit 12. The portion where the unmanned carrier robot 1 is in contact with the ground is, for example, the wheels 31, but is not limited thereto.

The unmanned carrier robot 1 determines whether the unmanned carrier robot 1 is separated from the ground by a certain distance or more (step S32). Specifically, the anomaly determination unit 12 detects the distance between the portion where the unmanned carrier robot 1 is in contact with the ground and the ground or the distance between the bottom surface of the unmanned carrier robot 1 and the ground using the imaging data received from the imaging device 13. In a case where the distance between the portion where the unmanned carrier robot 1 is in contact with the ground and the ground is detected, the certain distance is a threshold for determining that the unmanned carrier robot 1 is lifted and the portion in contact with the ground is separated from the ground. When the distance between the bottom surface of the unmanned carrier robot 1 and the ground is detected, the distance between the bottom surface and the ground at the normal time is obtained in advance by measurement as a standard distance, and the certain distance is set longer than the standard distance.

When the unmanned carrier robot 1 is not separated from the ground by the certain distance or more (No in step S 32), the process from step S31 is repeated. When the unmanned carrier robot 1 is separated from the ground by the certain distance or more (Yes in step S32), the unmanned carrier robot 1 provides notification of the anomaly (step S33), and the process from step S31 is repeated. The anomaly notification method in step S33 is similar to that in step S7.

As described above, in the fourth anomaly determination process, the monitoring information includes the second imaging data obtained by imaging the area below the unmanned carrier robot 1, and the anomaly determination unit 12 determines an anomaly when the distance between the unmanned carrier robot 1 and the reference surface orthogonal to the vertical direction becomes equal to or longer than a certain distance using the second imaging data.

As described above, the four processes of the first anomaly determination process, the second anomaly determination process, the third anomaly determination process, and the fourth anomaly determination process have been described as examples, but the anomaly determination processes performed by the anomaly determination unit 12 are not limited to these examples. For example, the anomaly determination unit 12 may acquire the position information from the self-position identification unit 17, and determine that the unmanned carrier robot 1 is abnormal when the unmanned carrier robot 1 is away from the route specified by the control information from the management device 5 by a predetermined distance or more using the position information.

In the above-described example, the anomaly determination unit 12 performs the first anomaly determination process, the second anomaly determination process, the third anomaly determination process, and the fourth anomaly determination process, but the present disclosure is not limited thereto, and the anomaly determination unit 12 only needs to perform at least one of the first anomaly determination process, the second anomaly determination process, the third anomaly determination process, the fourth anomaly determination process, and other anomaly determination processes. For example, the anomaly determination unit 12 may perform only the first anomaly determination process, and in this case, the imaging device 13 and the opening/closing sensor 22 may not be provided. Furthermore, in this case, the authentication unit 15 and the anomaly determination unit 12 may be integrated, and the authentication unit 15 may also have a function as the anomaly determination unit 12.

Furthermore, in a case where a plurality of anomaly determination processes is performed, the anomaly determination unit 12 may also provide notification of the content of the anomaly including information indicating which anomaly determination process has determined the anomaly when providing notification of the anomaly. For example, when the anomaly is determined in the first anomaly determination process, the content of the anomaly includes information indicating that the number of authentication failures is equal to or larger than the threshold, and when the anomaly is determined in the second anomaly determination process, the content of the anomaly includes information indicating that the door 21 is opened in a state where the authentication is not successful. Further, when the anomaly is determined in the third anomaly determination process, the content of the anomaly includes information indicating that a person who performs a suspicious behavior is present near the unmanned carrier robot 1, and when the anomaly is determined in the fourth anomaly determination process, the content of the anomaly includes information indicating that the unmanned carrier robot 1 is separated from the ground. In addition, when the anomaly is determined in the third anomaly determination process, if the type of suspicious behavior is also determined, the type of suspicious behavior may be included in the content of the anomaly. The administrator can take a measure corresponding to the content of the anomaly by checking the content of the anomaly.

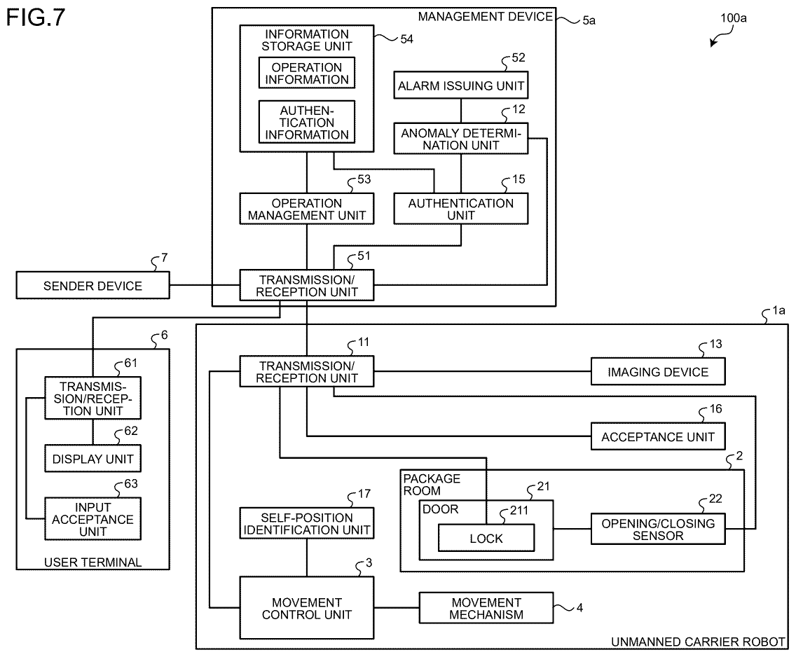

In the above example, the anomaly determination unit 12 is provided in the unmanned carrier robot 1, but the present disclosure is not limited thereto, and the anomaly determination unit 12 may be provided in the management device. FIG. 7 is a diagram illustrating an exemplary configuration of the carrier system of the present embodiment in a case where the anomaly determination unit 12 is provided in the management device. The carrier system 100a illustrated in FIG. 7 includes an unmanned carrier robot 1a and a management device 5a. In the management device 5a, the authentication unit 15 and the anomaly determination unit 12 are added to the management device 5 illustrated in FIG. 1. In the unmanned carrier robot 1a illustrated in FIG. 7, the authentication information storage unit 14, the authentication unit 15, and the anomaly determination unit 12 are deleted from the unmanned carrier robot 1 illustrated in FIG. 1. Components having the same functions as those in FIG. 1 are denoted by the same reference signs as in FIG. 1, and redundant explanations are omitted.

In the exemplary configuration illustrated in FIG. 7, the authentication information accepted by the acceptance unit 16 is transmitted to the management device 5a by the transmission/reception unit 11. In the management device 5a, the authentication unit 15 receives the authentication information from the unmanned carrier robot 1a via the transmission/reception unit 51, performs the authentication process by collating the received authentication information with the authentication information stored in the information storage unit 54, and outputs the authentication result to the anomaly determination unit 12. In addition, in the exemplary configuration illustrated in FIG. 7, imaging data acquired by the imaging device 13 and a detection result by the opening/closing sensor 22 are also transmitted to the management device 5a via the transmission/reception unit 11. The anomaly determination unit 12 receives the imaging data acquired by the imaging device 13 and the detection result by the opening/closing sensor 22 via the transmission/reception unit 51. The anomaly determination unit 12 acquires information to be used for anomaly determination from the unmanned carrier robot 1a to perform the anomaly determination process similarly to the exemplary configuration illustrated in FIG. 1, and when determining that an anomaly has occurred, notifies the alarm issuing unit 52 of the anomaly. The alarm issuing unit 52 issues an alarm in response to the notification of the anomaly from the anomaly determination unit 12.

The separation of the functions between the unmanned carrier robot and the management device is not limited to the example illustrated in FIGS. 1 and 7. For example, in the example shown in FIG. 7, the authentication unit 15 may be added to the unmanned carrier robot 1a, and the authentication unit 15 may be deleted from the management device 5a. Further, for example, in the example shown in FIG. 7, the anomaly determination unit 12 may be added to the unmanned carrier robot 1a, and the anomaly determination unit 12 may be deleted from the management device 5a. In these cases, the authentication result of the authentication unit 15 is transmitted to the anomaly determination unit 12 via the transmission/reception unit 11 and the transmission/reception unit 51.

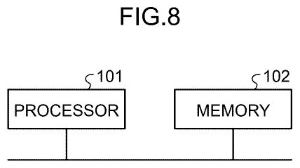

Next, a hardware configuration of the control device in the unmanned carrier robot 1 of the present embodiment will be described. The control device in the unmanned carrier robot 1 includes the anomaly determination unit 12, the authentication information storage unit 14, the authentication unit 15, and the movement control unit 3. As described above, the anomaly determination unit 12, the authentication information storage unit 14, the authentication unit 15, and the movement control unit 3 may be divided into two or more control devices. In the control device according to the present embodiment, a program (computer program) describing the processes in the control device is executed on a computer system, so that the computer system functions as the control device. The computer system includes, for example, processing circuitry. FIG. 8 is a diagram illustrating an exemplary configuration of processing circuitry that implements the control device of the present embodiment. As illustrated in FIG. 8, the processing circuitry includes a processor 101 and a memory 102. The processing circuitry may be one circuit or a plurality of circuits. These are connected via a system bus.

In FIG. 8, the processor 101 is, for example, a control unit such as a central processing unit (CPU), and executes a program describing the processes in the control device according to the present embodiment. The memory 102 includes various types of memories such as a random access memory (RAM) and a read only memory (ROM) and a storage device such as a hard disk, and stores programs to be executed by the processor 101 and necessary data obtained during processing. The memory 102 is also used as a temporary storage area for programs.

Here, an example of how the computer system operates until the program according to the present embodiment becomes executable will be described. In the computer system having the above-mentioned configuration, for example, the program is installed on the memory 102 from a compact disc (CD)-ROM or digital versatile disc (DVD)-ROM set in a CD-ROM drive or DVD-ROM drive (not illustrated). Then, when the program is executed, the program read from the memory 102 is stored in the main storage area of the memory 102. In this state, the processor 101 executes the processing as the control device of the present embodiment according to the program stored in the memory 102.

In the above description, the program describing the processes in the control device is provided using a CD-ROM or DVD-ROM as a recording medium. Alternatively, the program may be provided by a transmission medium such as the Internet via the communication unit (not illustrated) according to the configuration of the computer system, the capacity of the program, and the like.

The program of the present embodiment causes, for example, a computer system that controls the unmanned carrier robot 1 that carries a package to a user to execute a step of determining presence or absence of an anomaly in security related to the package on the basis of monitoring information, and a step of providing notification of occurrence of the anomaly in response to a determination of the anomaly. This computer system may be the control device in the unmanned carrier robot 1 or may be the management device 5.

The anomaly determination unit 12, the authentication unit 15, and the movement control unit 3 illustrated in FIG. 1 are implemented by the processor 101 illustrated in FIG. 8 executing the program stored in the memory 102 illustrated in FIG. 8. The memory 102 illustrated in FIG. 8 is also used to implement the anomaly determination unit 12, the authentication unit 15, and the movement control unit 3 illustrated in FIG. 1. The authentication information storage unit 14 illustrated in FIG. 1 is a part of the memory 102 illustrated in FIG. 8.

The management device 5 illustrated in FIG. 1 is also implemented by a computer system including the processing circuitry illustrated in FIG. 8. Note that the computer system that implements the management device 5 includes a communication unit (not illustrated) including a transmitter and a receiver in addition to the processing circuitry. In addition, the computer system that implements the management device 5 may further include an input unit and/or a display unit.

The transmission/reception unit 51 illustrated in FIG. 1 is implemented by a communication unit. The operation management unit 53 is implemented by the processor 101 illustrated in FIG. 8 executing the program stored in the memory 102 illustrated in FIG. 8. The memory 102 illustrated in FIG. 8 is also used to implement the operation management unit 53 illustrated in FIG. 1. The information storage unit 54 illustrated in FIG. 1 is a part of the memory 102 illustrated in FIG. 8. The alarm issuing unit 52 illustrated in FIG. 1 may be implemented by a display unit (not illustrated) included in a computer system that implements the management device 5, may be implemented by a speaker included in the computer system that implements the management device 5, or may be implemented by a display device, a speaker, a lamp, or the like connected to the computer system that implements the management device 5.

Similarly to the management device 5, the management device 5a of the exemplary configuration illustrated in FIG. 7 is also implemented by, for example, a computer system including the processing circuitry illustrated in FIG. 8. A control device (not illustrated) in the unmanned carrier robot 1a illustrated in FIG. 7 is also implemented by a computer system including the processing circuitry illustrated in FIG. 8. The control device in the unmanned carrier robot 1a illustrated in FIG. 7 includes the movement control unit 3.

As described above, in the present embodiment, the anomaly determination unit 12 determines whether there is an anomaly in security in the unmanned carrier robot 1, and provides notification of the anomaly in response to a determination of the anomaly. As a result, the unmanned carrier robot 1 of the present embodiment can enhance security.

### Second Embodiment

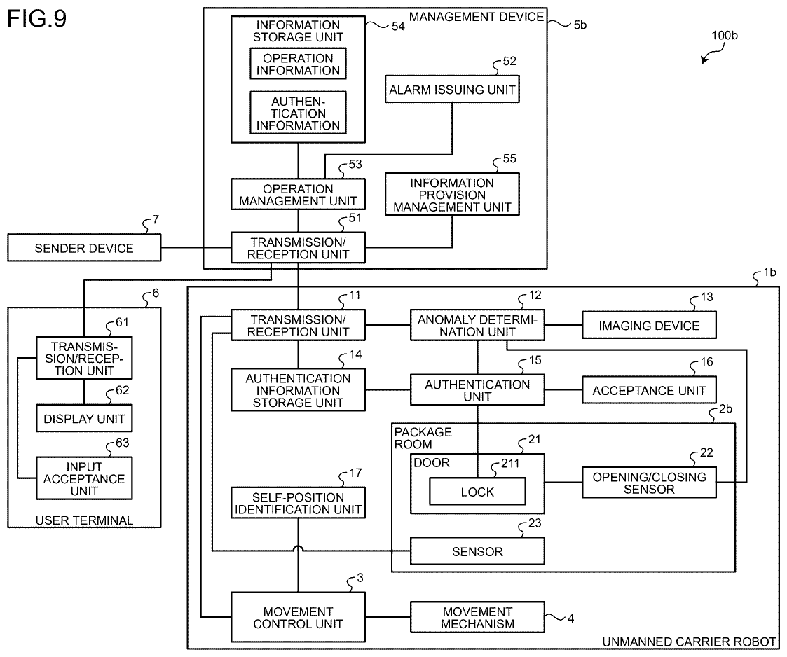

FIG. 9 is a diagram illustrating an exemplary configuration of a carrier system according to the second embodiment. The carrier system 100b of the present embodiment includes an unmanned carrier robot 1b and a management device 5b. Components having the same functions as those in the first embodiment are explained by being denoted by the same reference signs as those in the first embodiment. Hereinafter, differences from the first embodiment will be mainly described.

The unmanned carrier robot 1b according to the present embodiment carries a package to a user as in the first embodiment. Since the package is carried in an unmanned manner, it is assumed that the user may feel anxiety about the status of the package being carried. The status of the package includes, for example, the state of the package itself and/or an environment around the package, that is, an environment in the package room 2b. In the present embodiment, the user's anxiety is reduced by providing the user with information indicating the status of the package being carried.

The unmanned carrier robot 1b of the present embodiment corresponds to the unmanned carrier robot 1 of the first embodiment, but the unmanned carrier robot 1b includes the package room 2b instead of the package room 2. In the package room 2b, a sensor 23 is added to the package room 2 of the first embodiment. The sensor 23 detects the state of the package in the package room 2b and/or an environment around the package, and outputs a detection result to the transmission/reception unit 11 as sensor information. The environment around the package is, for example, the environment of the package room 2b, but is not limited thereto. The sensor information is an example of information indicating the status of the package, and is information indicating the state of the package in the package room 2b and/or the environment in the package room 2b. The transmission/reception unit 11 transmits the sensor information received from the sensor 23 to the management device 5b. The sensor 23 may be an imaging device that images the inside of the package room 2b, a sensor that detects vibration of the package, or a sensor that detects at least one of temperature, humidity, pressure, and odor of the package room 2b. In a case where an imaging device that images the inside of the package room 2b is used as the sensor 23, a night-vision camera may be used as the imaging device, or a visible light camera may be used as the imaging device by providing an illumination device in the package room 2b. Note that, in a case where the package room 2b is not provided, the sensor 23 may be a sensor that detects at least one of temperature, humidity, pressure, and odor of the holding unit, or may be an imaging device that images the holding unit or the surroundings of the package. Although one sensor 23 is illustrated in FIG. 9, the number of sensors 23 only needs to be one or more, and the number of sensors 23 is not limited to the example illustrated in FIG. 9.

In the management device 5b of the present embodiment, an information provision management unit 55 is added to the management device 5 of the first embodiment. When receiving an information provision request indicating that the provision of sensor information is requested from the user terminal 6 via the transmission/reception unit 51, the information provision management unit 55 instructs the unmanned carrier robot 1b to provide the sensor information via the transmission/reception unit 51. As a result, the sensor 23 of the unmanned carrier robot 1b transmits the sensor information to the management device 5b via the transmission/reception unit 11. Upon receiving the sensor information via the transmission/reception unit 51, the information provision management unit 55 of the management device 5b transmits the received sensor information to the user terminal 6 via the transmission/reception unit 51. Alternatively, when receiving the information provision request from the user terminal 6 via the transmission/reception unit 51, the information provision management unit 55 may instruct the unmanned carrier robot 1b to transmit the sensor information to the user terminal 6 via the transmission/reception unit 51. In this case, the information provision management unit 55 notifies the unmanned carrier robot 1b of information for transmitting the sensor information to the user terminal 6, and the transmission/reception unit 11 of the unmanned carrier robot 1b transmits the sensor information to the user terminal 6.

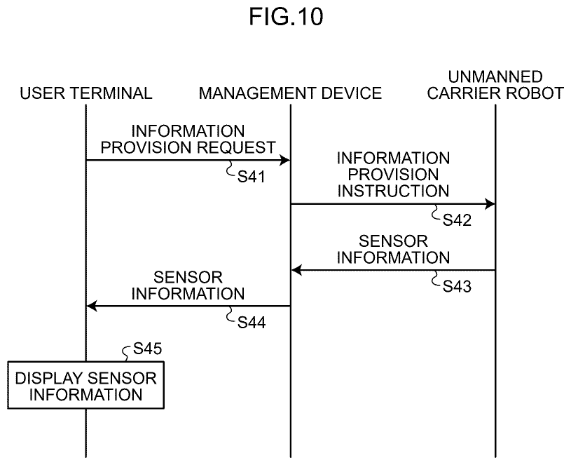

FIG. 10 is a sequence diagram illustrating an example of a process of providing sensor information according to the present embodiment. As illustrated in FIG. 10, the user terminal 6 transmits an information provision request to the management device 5b (step S41). Specifically, the input acceptance unit 63 accepts an input of an information provision request indicating that provision of the sensor information is requested from the user, and outputs the accepted information provision request to the transmission/reception unit 61, and the transmission/reception unit 61 transmits the information provision request to the management device 5b.

Upon receiving the information provision request, the management device 5b transmits an information provision instruction to the unmanned carrier robot 1b (step S42). Specifically, when receiving the information provision request from the transmission/reception unit 51, the information provision management unit 55 of the management device 5b generates an information provision instruction indicating an instruction to provide the sensor information, and transmits the generated information provision instruction to the unmanned carrier robot 1b via the transmission/reception unit 51.

Upon receiving the information provision instruction, the unmanned carrier robot 1b transmits the sensor information to the management device 5b (step S43). Specifically, when receiving the information provision instruction, the transmission/reception unit 11 outputs the received information provision instruction to the sensor 23, and when receiving the information provision instruction, the sensor 23 outputs the sensor information to the transmission/reception unit 11, and the transmission/reception unit 11 transmits the sensor information received from the sensor 23 to the management device 5b.

Upon receiving the sensor information, the management device 5b transmits the received sensor information to the user terminal 6 (step S44). Specifically, the transmission/reception unit 51 receives the sensor information, outputs the received sensor information to the information provision management unit 55, and the information provision management unit 55 transmits the sensor information received from the transmission/reception unit 51 to the user terminal 6 via the transmission/reception unit 51. Alternatively, the information provision management unit 55 may instruct the transmission/reception unit 51 to transfer the sensor information to the user terminal 6 when the sensor information is received from the unmanned carrier robot 1b, and the transmission/reception unit 51 may transfer the sensor information received from the unmanned carrier robot 1b to the user terminal 6 according to the instruction. In this manner, the sensor information is transmitted from the transmission/reception unit 11 to the user terminal 6 via the management device 5b or directly from the transmission/reception unit 11 to the user terminal 6. Therefore, the transmission/reception unit 11 is a provision unit that provides the sensor information to the user corresponding to the package.

The user terminal 6 that has received the sensor information displays the sensor information (step S45). Specifically, the transmission/reception unit 61 receives the sensor information, outputs the received sensor information to the display unit 62, and the display unit 62 displays the sensor information. The user can grasp the state of the package and/or the environment in the package room 2b by visually recognizing the sensor information displayed on the user terminal 6. As a result, the user's anxiety can be reduced.

For example, by displaying the imaging data as the sensor information, the user can confirm whether the package is collapsed, whether the vibration of the package is too intense, whether the package is contaminated, and the like. Furthermore, by displaying the data indicating the temperature as the sensor information, the user can confirm whether the package is being carried in a normal temperature environment. When the user checks the sensor information and determines that the state of the package or the environment in the package room 2b is abnormal, the user may contact the sender or the administrator of the carrier system 100b to request improvement.

In the above-described example, the management device 5b acquires the sensor information from the unmanned carrier robot 1b when receiving the information provision request, but the management device 5b may receive the sensor information, for example, periodically and store the sensor information in the information storage unit 54 regardless of whether the information provision request is received. In this case, upon receiving the information provision request from the transmission/reception unit 51, the information provision management unit 55 of the management device 5b stores the information in the information storage unit 54, and transmits the sensor information received from the unmanned carrier robot 1b to the user terminal 6 via the transmission/reception unit 51. Furthermore, in this case, in a case where there is a request for providing past sensor information from the user terminal 6, the information provision management unit 55 of the management device 5b may read the corresponding sensor information from the information storage unit 54 and transmit the read sensor information to the user terminal 6 via the transmission/reception unit 51.

Furthermore, in the above-described example, the management device 5b transmits the sensor information to the user terminal 6, but may process the sensor information and transmit the processed information to the user terminal 6. For example, in a case where the sensor information is imaging data, the information provision management unit 55 may generate information in which the resolution of the imaging data received from the unmanned carrier robot 1b is reduced, and transmit the generated information to the user terminal 6 via the transmission/reception unit 51. Furthermore, in a case where a plurality of sensors 23 is provided, the information provision management unit 55 may generate display information for displaying the sensor information of the plurality of sensors 23 on one screen, and transmit the generated display information to the user terminal 6 via the transmission/reception unit 51.

The separation of the functions of the management device and the unmanned carrier robot is not limited to the example illustrated in FIG. 9. For example, in the exemplary configuration illustrated in FIG. 7 of the first embodiment, the sensor 23 may be added to the unmanned carrier robot 1a of the first embodiment, the information provision management unit 55 may be added to the management device 5a, and the operation described in the present embodiment may be performed.

In the example described above, the operation of the present embodiment is performed after the anomaly determination process described in the first embodiment is performed, but the present disclosure is not limited thereto, and the operation of the present embodiment may be performed without performing the anomaly determination process described in the first embodiment. In this case, the unmanned carrier robot 1b may not include the anomaly determination unit 12, the opening/closing sensor 22, and the imaging device 13, and the management device 5b may not include the alarm issuing unit 52.

Similarly to the management device 5 of the first embodiment, the management device 5b of the present embodiment is also implemented by, for example, a computer system including the processing circuitry illustrated in FIG. 8. A control device (not illustrated) in the unmanned carrier robot 1b is also implemented by a computer system including the processing circuitry illustrated in FIG. 8. The information provision management unit 55 is implemented by the processor 101 illustrated in FIG. 8 executing the program stored in the memory 102 illustrated in FIG. 8. The memory 102 illustrated in FIG. 8 is also used to implement the information provision management unit 55.

As described above, in the present embodiment, the carrier system 100b transmits the sensor information indicating the state of the package in the package room 2b of the unmanned carrier robot 1b and/or the environment in the package room 2b to the user terminal 6. As a result, the user can grasp the status of the package, and the anxiety of the user can be reduced.

### Third Embodiment

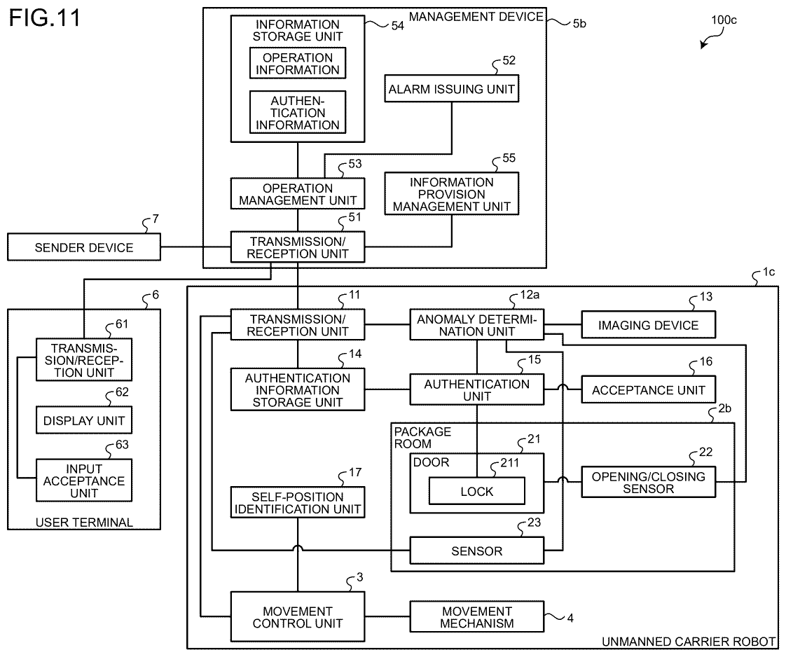

FIG. 11 is a diagram illustrating an exemplary configuration of a carrier system according to the third embodiment. The carrier system 100c of the present embodiment includes an unmanned carrier robot 1c and the management device 5b similar to that of the second embodiment. Components having the same functions as those in the second embodiment are explained by being denoted by the same reference signs as those in the second embodiment. Hereinafter, differences from the second embodiment will be mainly described.

The unmanned carrier robot 1c of the present embodiment is similar to the unmanned carrier robot 1b of the second embodiment except that an anomaly determination unit 12a is provided instead of the anomaly determination unit 12. In the present embodiment, the sensor 23 also outputs sensor information to the anomaly determination unit 12a. The anomaly determination unit 12a performs the process of determining the presence or absence of the anomaly in security described in the first embodiment, and analyzes the sensor information acquired by the sensor 23 to determine the presence or absence of an anomaly (status anomaly) in the package room 2b. The anomaly in the package room 2b is an example of an anomaly in the environment around the package.

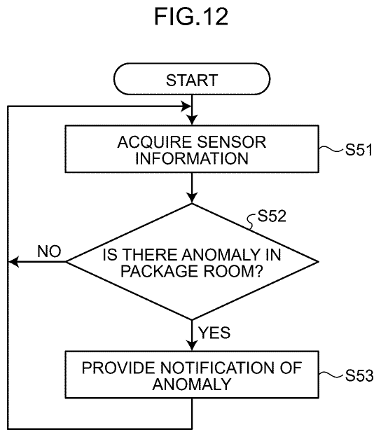

FIG. 12 is a flowchart illustrating an example of the anomaly determination process according to the present embodiment. The process illustrated in FIG. 12 is started, for example, during a period from when a package is loaded on the unmanned carrier robot 1c and the door is locked to when the unmanned carrier robot 1c departs to the destination of the package, but the timing at which the process illustrated in FIG. 12 is started is not limited thereto.

As illustrated in FIG. 12, the unmanned carrier robot 1c acquires sensor information (step S51). Specifically, similarly to the second embodiment, the sensor 23 detects the state of the package in the package room 2b and/or the environment in the package room 2b. The sensor 23 outputs the detection result to the anomaly determination unit 12a as sensor information.

Next, the unmanned carrier robot 1c determines whether there is an anomaly in the package room 2b (step S52). Specifically, the anomaly determination unit 12a determines whether there is an anomaly in the package room 2b by using the sensor information received from the sensor 23.

For example, in a case where the sensor information is imaging data obtained by imaging a package in the package room 2b, the anomaly determination unit 12a extracts a region corresponding to the package from the video indicated by the imaging data, and determines that there is an anomaly in the package room 2b in a case where the extracted region changes by a certain amount or more from the time of loading the package. For example, when a package falls or is deformed due to impact or the like, a region corresponding to the package in the image changes. The anomaly determination unit 12a can detect an anomaly such as falling or deformation of the package by detecting a change in the region corresponding to the package in the image. In addition, in a case where the sensor information is imaging data obtained by imaging the package in the package room 2b, the anomaly determination unit 12a may determine that there is an anomaly in the package room 2b in a case where the package in the video is contaminated. Whether the package is contaminated may be determined based on, for example, a change in the color of the region corresponding to the package. In addition, in a case where the sensor information is imaging data obtained by imaging the inside of the package room 2b, the anomaly determination unit 12a may determine that there is an anomaly in the package room 2b when there is dirt in the package room 2b.

In addition, in a case where the sensor information is a detection result of the temperature in the package room 2b, the anomaly determination unit 12a may determine that there is an anomaly in the package room 2b in a case where the temperature deviates from a predetermined normal range. In addition, also in a case where the sensor information is a detection result of pressure, humidity, and vibration, the anomaly determination unit 12a may similarly determine that there is an anomaly in the package room 2b in a case where a value indicated by the sensor information deviates from a predetermined normal range.

When there is no anomaly in the package room 2b (No in step S52), the process from step S51 is repeated. When there is an anomaly in the package room 2b (Yes in step S52), the unmanned carrier robot 1c provides notification of anomaly (step S53), and the process from step S51 is repeated. The method of notifying the anomaly is similar to step S7 of the first embodiment, and the notification destination of the anomaly may be the management device 5b, and the user terminal 6 and/or the sender device 7 may be included. In addition, the user terminal 6 and the sender device 7 may be notified of the anomaly from the management device 5b. Note that, as described in the first embodiment, notification of the content of the anomaly may also be provided at the time of notification of the anomaly. In step S53, notification of the anomaly in the package room 2b may be provided, and the content of the anomaly may be provided in more detail, such as that contamination is detected in the package room 2b, or the temperature becomes higher than the normal range.

The separation of the functions of the management device and the unmanned carrier robot is not limited to the example illustrated in FIG. 11. For example, in the exemplary configuration illustrated in FIG. 7 of the first embodiment, the sensor 23 may be added to the unmanned carrier robot 1a of the first embodiment, the information provision management unit 55 may be added to the management device 5a, and the management device 5a may include the anomaly determination unit 12a instead of the anomaly determination unit 12 to perform the operation described in the present embodiment. In addition to the anomaly determination unit 12 described in the first embodiment, an anomaly determination unit that determines an anomaly in the package room 2b of the present embodiment may be provided. For example, when the anomaly determination unit 12 described in the first embodiment is defined as a first anomaly determination unit and the anomaly determination unit that determines an anomaly in the package room 2b of the present embodiment is defined as a second anomaly determination unit, both the first anomaly determination unit and the second anomaly determination unit may be provided in the unmanned carrier robot 1c or may be provided in the management device 5b. Alternatively, the first anomaly determination unit may be provided in the unmanned carrier robot 1c and the second anomaly determination unit may be provided in the management device 5b, or the second anomaly determination unit may be provided in the unmanned carrier robot 1c and the first anomaly determination unit may be provided in the management device 5b.

In the example described above, the operation of the present embodiment is performed after the anomaly determination process described in the first embodiment is performed, but the present disclosure is not limited thereto, and the operation of the present embodiment may be performed without performing the anomaly determination process described in the first embodiment. In this case, the unmanned carrier robot 1c may include the second anomaly determination unit described above instead of the anomaly determination unit 12a, and may not include the opening/closing sensor 22 and the imaging device 13, and the management device 5b may not include the alarm issuing unit 52. In addition, without performing the operation of providing the sensor information described in the second embodiment to the user terminal 6, the determination of an anomaly in the package room 2b using the sensor information in the present embodiment may be performed. In this case, the sensor information may not be transmitted to the management device 5b.

A control device (not illustrated) in the unmanned carrier robot 1c of the present embodiment is also implemented by a computer system including the processing circuitry illustrated in FIG. 8. The control device includes, for example, the anomaly determination unit 12a, the authentication information storage unit 14, the authentication unit 15, and the movement control unit 3. The anomaly determination unit 12a in the control device is implemented by the processor 101 illustrated in FIG. 8 executing the program stored in the memory 102 illustrated in FIG. 8. The memory 102 illustrated in FIG. 8 is also used to implement the anomaly determination unit 12a.

As described above, in the present embodiment, the carrier system 100c determines an anomaly in the package room 2b of the unmanned carrier robot 1c. In a case where the inside of the package room 2b is not monitored, the occurrence of an anomaly remains unknown until the unmanned carrier robot 1c arrives at the user's place. However, in the present embodiment, since it is possible to grasp that the anomaly has occurred in the package room 2b during carry, it is possible to quickly take measures.

### Fourth Embodiment

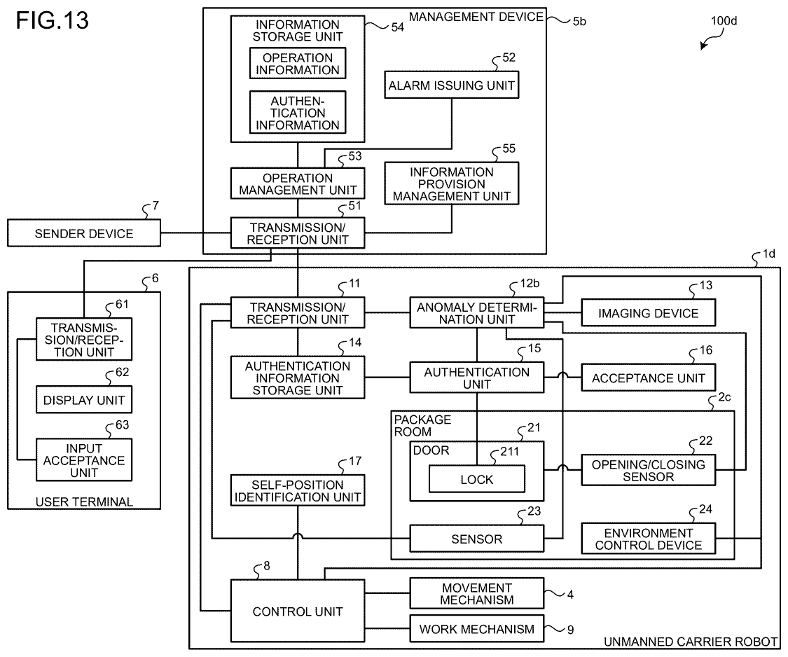

FIG. 13 is a diagram illustrating an exemplary configuration of a carrier system according to the fourth embodiment. The carrier system 100d of the present embodiment includes an unmanned carrier robot 1d and the management device 5b similar to that of the third embodiment. Components having the same functions as those in the third embodiment are explained by being denoted by the same reference signs as those in the third embodiment. Hereinafter, differences from the third embodiment will be mainly described.

The unmanned carrier robot 1d of the present embodiment is similar to the unmanned carrier robot 1c of the third embodiment except that a work mechanism 9 is added to the unmanned carrier robot 1c of the third embodiment and an anomaly determination unit 12b, a package room 2c, and a control unit 8 are provided instead of the anomaly determination unit 12a, the package room 2b, and the movement control unit 3.

The package room 2c is similar to the package room 2b of the third embodiment except that an environment control device 24 is added. The environment control device 24 controls the environment in the package room 2c. The environment in the package room 2c is an example of the environment around the package. The environment control device 24 controls, for example, at least one of temperature, humidity, and pressure in the package room 2c. For example, in a case where the detection result of the temperature is used as the sensor information, a device capable of adjusting the temperature in the package room 2c is used as the environment control device 24. In a case where the detection result of the humidity is used as the sensor information, a device capable of adjusting the humidity in the package room 2c is used as the environment control device 24. In a case where the detection result of the pressure is used as the sensor information, a device capable of adjusting the pressure in the package room 2c is used as the environment control device 24. Note that the temperature and humidity in the package room 2c are examples of the temperature and humidity around the package, respectively.

Similarly to the anomaly determination unit 12a of the third embodiment, the anomaly determination unit 12b determines the anomaly in the package room 2c using the sensor information. When it is determined that there is an anomaly in the package room 2c, the anomaly determination unit 12b transmits instruction information indicating an instruction for resolving the anomaly to an anomaly handling device which is the control unit 8 and/or the environment control device 24, thereby causing the anomaly handling device to execute control for resolving the anomaly.

Similarly to the movement control unit 3 of the first embodiment, the control unit 8 controls the movement mechanism 4 and controls the work mechanism 9 that performs work. The work mechanism 9 is, for example, a robot arm, but is not limited thereto as long as it is a mechanism capable of adjusting a package such as moving the position of the package or changing the orientation of the package.

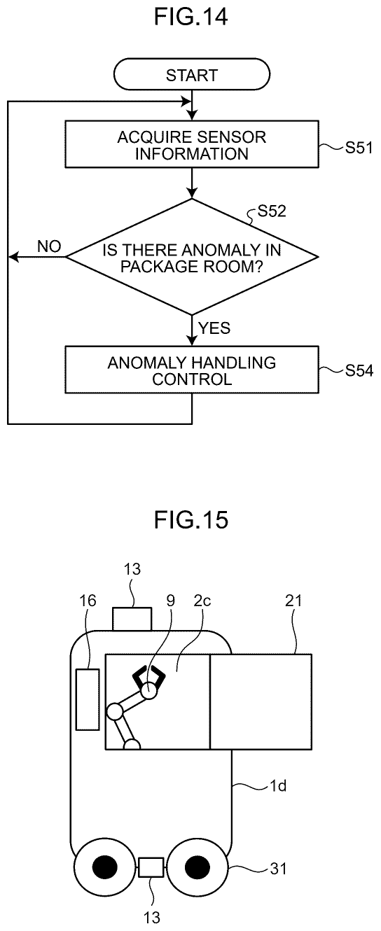

FIG. 14 is a flowchart illustrating an example of the anomaly determination process according to the present embodiment. The process illustrated in FIG. 14 is started, for example, during a period from when a package is loaded on the unmanned carrier robot 1d and the door is locked to when the unmanned carrier robot 1d departs to the destination of the package, but the timing at which the process illustrated in FIG. 14 is started is not limited thereto.

The process illustrated in FIG. 14 is similar to the process illustrated in FIG. 12 of the third embodiment except that step S54 is performed instead of step S53. If Yes in step S52, the unmanned carrier robot 1d performs anomaly handling control (step S54). Specifically, the anomaly determination unit 12b transmits instruction information indicating an instruction for resolving the anomaly to the anomaly handling device which is the control unit 8 and/or the environment control device 24. Then, the anomaly handling device executes anomaly handling control, which is control for resolving an anomaly, based on the instruction information.

For example, in a case where the sensor information includes temperature information that is a detection result of the temperature in the package room 2c, the anomaly determination unit 12b uses the temperature information in step S52 to determine that there is an anomaly in response to a determination that the temperature in the package room 2c deviates from the normal range, and controls the environment control device 24 such that the temperature of the package room 2c is within the normal range. In this case, the environment control device 24 can control the temperature of the package room 2c. For example, the anomaly determination unit 12b generates instruction information indicating an instruction to adjust the temperature in order to set the temperature within the normal range, and transmits the generated instruction information to the environment control device 24. The environment control device 24 adjusts the temperature in the package room 2c on the basis of the instruction information. For example, in a case where the temperature becomes higher than the normal range, the anomaly determination unit 12b generates instruction information indicating an instruction to decrease the temperature, and in a case where the temperature becomes lower than the normal range, the anomaly determination unit 12b generates instruction information indicating an instruction to increase the temperature.

Similarly, in a case where the sensor information includes humidity information that is a detection result of the humidity in the package room 2c, the anomaly determination unit 12b uses the humidity information to determine that there is an anomaly in response to a determination that there is an anomaly due to the humidity deviating from the normal range, and controls the environment control device 24 such that the humidity in the package room 2c is within the normal range. In this case, the environment control device 24 can control the humidity of the package room 2c. For example, the anomaly determination unit 12b generates instruction information indicating an instruction for the environment control device 24 to adjust the humidity in order to set the humidity within the normal range, and transmits the generated instruction information to the environment control device 24.

Similarly, in a case where the sensor information includes pressure information that is a detection result of the pressure in the package room 2c, the anomaly determination unit 12b uses the pressure information to determine that there is an anomaly in response to a determination that there is an anomaly due to the pressure deviating from the normal range, and controls the environment control device 24 such that the pressure in the package room 2c is within the normal range. In this case, the environment control device 24 can control the pressure in the package room 2c. For example, the anomaly determination unit 12b generates instruction information indicating an instruction for the environment control device 24 to adjust the pressure in order to set the pressure within the normal range, and transmits the generated instruction information to the environment control device 24. In FIG. 13, the environment control device 24 is included in the package room 2c, but the environment control device 24 may be provided outside the package room 2c.

In addition, for example, in a case where the sensor information includes imaging data obtained by imaging the package in the package room 2c, when it is determined in step S52 that there is an anomaly due to detection of overturning of the package, the anomaly determination unit 12b generates instruction information indicating an instruction for the control unit 8 to correct the orientation of the package, and transmits the generated instruction information to the control unit 8. The control unit 8 resolves the anomaly by controlling the work mechanism 9 based on the instruction information. In this case, the sensor information includes imaging data (third imaging data) obtained by imaging the package, and the anomaly determination unit 12b determines whether the orientation of the package is abnormal using the imaging data, determines that there is an anomaly in the package room 2c in response to a determination that the orientation of the package is abnormal, and instructs the control unit 8 to return the orientation of the package to the correct orientation by the work mechanism 9. When instructed by the anomaly determination unit 12b to return the orientation of the package to the correct orientation, the control unit 8 controls the work mechanism 9 such that the work mechanism 9 returns the orientation of the package to the correct orientation. The anomaly determination unit 12b may instruct the control unit 8 on a specific rotation direction, rotation amount, and the like for returning the package to the correct orientation, or may output information indicating the correct orientation to the work mechanism 9. The control unit 8 may control the work mechanism 9 using third imaging data that is sensor information acquired by the sensor 23, or may control the work mechanism 9 on the basis of information acquired by a sensor different from the sensor 23 provided for controlling the work mechanism 9.

FIG. 15 is a diagram illustrating an example of the work mechanism 9 of the present embodiment. In the example illustrated in FIG. 15, a robot arm is used as the work mechanism 9. As illustrated in FIG. 15, for example, the work mechanism 9 is provided in the package room 2c, and can correct the orientation of the package and move the position of the package. Note that FIG. 15 is an example, and the shape, size, and arrangement position of the work mechanism 9 are not limited to the example illustrated in FIG. 15.

Note that, in the example illustrated in FIG. 14, step S54 is performed instead of step S53, but the present disclosure is not limited thereto, and both step S53 and step S54 may be performed. In the example illustrated in FIG. 13, both the environment control device 24 and the control unit 8 are provided as the anomaly handling device, but the present invention is not limited thereto, and the anomaly handling device may be the environment control device 24 or the control unit 8.

The separation of the functions of the management device and the unmanned carrier robot is not limited to the example illustrated in FIG. 13. For example, in the exemplary configuration illustrated in FIG. 7 of the first embodiment, the sensor 23 may be added to the unmanned carrier robot 1a of the first embodiment, the information provision management unit 55 may be added to the management device 5a, and the management device 5a may include the anomaly determination unit 12b instead of the anomaly determination unit 12 to perform the operation described in the present embodiment. In addition to the anomaly determination unit 12 described in the first embodiment, an anomaly determination unit that determines an anomaly in the package room 2c and handles the anomaly of the present embodiment may be provided. For example, when the anomaly determination unit 12 described in the first embodiment is defined as a first anomaly determination unit and the anomaly determination unit that determines an anomaly in the package room 2c and handles the anomaly of the present embodiment is defined as a third anomaly determination unit, both the first anomaly determination unit and the third anomaly determination unit may be provided in the unmanned carrier robot 1d or may be provided in the management device 5b. Alternatively, the first anomaly determination unit may be provided in the unmanned carrier robot 1d and the third anomaly determination unit may be provided in the management device 5b, or the third anomaly determination unit may be provided in the unmanned carrier robot 1d and the first anomaly determination unit may be provided in the management device 5b.

In the example described above, the operation of the present embodiment is performed after the anomaly determination process described in the first embodiment is performed, but the present disclosure is not limited thereto, and the operation of the present embodiment may be performed without performing the anomaly determination process described in the first embodiment. In this case, the unmanned carrier robot 1d may include the third anomaly determination unit described above instead of the anomaly determination unit 12b, and may not include the opening/closing sensor 22 and the imaging device 13, and the management device 5b may not include the alarm issuing unit 52. In addition, without performing the operation of providing the sensor information described in the second embodiment to the user terminal 6, the determination of an anomaly in the package room 2c using the sensor information and anomaly handling in the present embodiment may be performed. In this case, the sensor information may not be transmitted to the management device 5b.

A control device (not illustrated) in the unmanned carrier robot 1d of the present embodiment is also implemented by a computer system including the processing circuitry illustrated in FIG. 8. The control device includes, for example, the anomaly determination unit 12b, the authentication information storage unit 14, the authentication unit 15, and the movement control unit 3. The anomaly determination unit 12b in the control device is implemented by the processor 101 illustrated in FIG. 8 executing the program stored in the memory 102 illustrated in FIG. 8. The memory 102 illustrated in FIG. 8 is also used to implement the anomaly determination unit 12b.

As described above, in the present embodiment, the carrier system 100d determines an anomaly in the package room 2c of the unmanned carrier robot 1d, and performs the anomaly handling control in response to a determination of the anomaly. Therefore, when an anomaly occurs in the package room 2c during carry, the anomaly can be corrected quickly.

The unmanned carrier robot according to the present disclosure can achieve the effect of enhancing security.

The configurations described in the above-mentioned embodiments indicate examples. The embodiments can be combined with another well-known technique and with each other, and some of the configurations can be omitted or changed in a range not departing from the gist.

What is claimed is:

1. An unmanned carrier robot that carries a package to a user, the unmanned carrier robot comprising:
anomaly determination circuitry to determine presence or absence of an anomaly in security related to the package on the basis of monitoring information indicating an occurrence state of an anomaly in security related to the package, and provide notification of occurrence of the anomaly in response to a determination of the anomaly.

2. The unmanned carrier robot according to claim 1, wherein the anomaly determination circuitry determines an unauthorized opening of a door of a holding unit that holds a package as the anomaly.

3. The unmanned carrier robot according to claim 2, wherein the anomaly determination circuitry determines the anomaly when the door is opened at a time other than a predetermined time after a determination of authentication success.

4. The unmanned carrier robot according to claim 2, comprising:
an input receiver to accept an input of authentication information to be used for authentication for unlocking a lock of a door of a holding unit that holds the package; and
authentication circuitry to perform authentication on the basis of the authentication information accepted by the input receiver, and output an authentication result, wherein
the anomaly determination circuitry determines the anomaly when the number of times of determination of an authentication failure by the authentication circuitry becomes equal to or larger than a threshold.

5. The unmanned carrier robot according to claim 1, wherein
the monitoring information includes first imaging data obtained by imaging surroundings of the unmanned carrier robot, and
the anomaly determination circuitry determines whether there is a person who performs a predetermined suspicious behavior within a range in which a distance from the unmanned carrier robot is within a predetermined distance using the first imaging data, and determines the anomaly in response to determining that there is a person who performs the suspicious behavior within the range.

6. The unmanned carrier robot according to claim 1, wherein
the monitoring information includes second imaging data obtained by imaging an area below the unmanned carrier robot, and
the anomaly determination circuitry determines the anomaly when a distance between the unmanned carrier robot and a reference surface orthogonal to a vertical direction becomes equal to or longer than a certain distance using the second imaging data.

7. The unmanned carrier robot according to claim 1, comprising
a transceiver comprising a transmitter and a receiver, wherein
in response to a determination of the anomaly, the anomaly determination circuitry generates anomaly information indicating occurrence of the anomaly, and provides notification of the anomaly by transmitting the anomaly information generated to a management device that manages the unmanned carrier robot via the transceiver.

8. The unmanned carrier robot according to claim 1, comprising:
a sensor to detect a state of the package and/or an environment around the package; and
provision circuitry to provide sensor information that is a detection result by the sensor to a user corresponding to the package.

9. The unmanned carrier robot according to claim 8, wherein the anomaly determination circuitry determines presence or absence of a status anomaly that is an anomaly of an environment around the package using the sensor information, and provides notification of the status anomaly in response to a determination of the status anomaly.

10. The unmanned carrier robot according to claim 9, comprising:
a work mechanism; and
control circuitry to control the work mechanism, wherein
the sensor information includes third imaging data obtained by imaging the package,
the anomaly determination circuitry determines whether an orientation of the package is abnormal using the third imaging data, determines the status anomaly in response to a determination that the orientation of the package is abnormal, and instructs the control circuitry to return the orientation of the package to a correct orientation by the work mechanism, and
the control circuitry controls the work mechanism such that the work mechanism returns the orientation of the package to the correct orientation when instructed by the anomaly determination circuitry to return the orientation of the package to the correct orientation.

11. The unmanned carrier robot according to claim 9, comprising
an environment controller to control a temperature around the package, wherein
the sensor information includes temperature information that is a detection result of the temperature around the package, and
the anomaly determination circuitry determines whether the temperature around the package deviates from a normal range by using the temperature information, determines the status anomaly in response to a determination that the temperature around the package deviates from the normal range, and controls the environment controller such that the temperature around the package is within the normal range.

12. The unmanned carrier robot according to claim 9, comprising
an environment controller to control a humidity around the package, wherein
the sensor information includes humidity information that is a detection result of the humidity around the package, and
the anomaly determination circuitry determines whether the humidity around the package deviates from a normal range by using the humidity information, determines the status anomaly in response to a determination that the humidity around the package deviates from the normal range, and controls the environment controller such that the humidity around the package is within the normal range.

13. The unmanned carrier robot according to claim 9, comprising
an environment controller to control a pressure of a holding unit that holds the package, wherein
the sensor information includes pressure information that is a detection result of the pressure in the holding unit, and
the anomaly determination circuitry determines whether the pressure in the holding unit deviates from a normal range by using the pressure information, determines the status anomaly in response to a determination that the pressure in the holding unit deviates from the normal range, and controls the environment controller such that the pressure in the holding unit is within the normal range.

14. A management device that manages an unmanned carrier robot that carries a package to a user, the management device comprising:
a receiver to receive, from the unmanned carrier robot, monitoring information indicating an occurrence state of an anomaly in security related to the package; and
anomaly determination circuitry to determine presence or absence of an anomaly in security related to the package on the basis of the monitoring information, and provide notification of occurrence of the anomaly in response to a determination of the anomaly.

15. A monitoring method for an unmanned carrier robot that carries a package to a user, the monitoring method comprising:
determining presence or absence of an anomaly in security related to the package on the basis of monitoring information indicating an occurrence state of an anomaly in security related to the package; and
providing notification of occurrence of the anomaly in response to a determination of the anomaly.
